(19) United States
(12) Patent Application Publication
(10) Pub. No.: US 2006/0127631 A1
(43) Pub. Date: Jun. 15, 2006

(54) Touch fastener assembly, a tool incorporating such a touch fastener assembly and a method for making an object which incorporates such a touch fastener assembly

(76) Inventor: Richard Keesler, Fowlerville, MI (US)

Correspondence Address: John G. Chupa;Law Offices of John Chupa and Associates, P.C., Suite 50, 28535 Orchard Lake Rd., Farmington Hills, MI, 48334, US

(21) Appl. No.: 11/007,853

(22) Filed: Dec. 9, 2004

(51) Int. Cl. D04H 11/00; B29C 67/20

(52) U.S. Cl. 428/85; 264/405; 425/3; 264/324; 264/321

(57) ABSTRACT

A touch fastener assembly 80 having opposed linear arrays 30, 33 of oppositely polarized magnetic material which cooperatively forms a magnetic field 70 which is constrained to exist in a predetermined area and volume and which is adapted to be operatively placed or integrally formed within a tool/mold 10 to allow a touch fastener assembly 80 to be accurately and reliably formed upon an object, such as a seat cushion, according to a new and novel method 100.

### FIELD OF THE INVENTION

The present invention generally relates to a touch fastener assembly, to a tool incorporating such a touch fastener assembly and to a method for making an object which incorporates such a touch fastener assembly and more particularly, to a touch fastener assembly which includes a magnetic field which is spatially constrained in a manner which is effective to allow a touch type fastener to be easily and accurately placed upon the touch fastener assembly and easily and accurately placed in a certain predetermined position within a tool in a manner which allows an object, such as a seat cushion assembly to be easily manufactured.

### BACKGROUND OF THE INVENTION

An object, such as a seat cushion, is typically manufactured in several steps. By way of example and without limitation, a foam cushion or “bunn” is initially and moldably created and is then substantially covered with material or fabric to form a seat cushion assembly having an overall desired aesthetic appearance and a desired overall utility. Particularly, in a typical case, the bunn includes at least one exposed and protruding touch type fastener assembly and the interior surface of the material (e. g., the term “interior surface” means the surface of the material or fabric which is actually in contact with the bunn) also includes a touch type fastener which operatively cooperates with the touch type fastener which is disposed upon the bunn to secure the material over the bunn in a firm and secure manner.

To dispose the touch type fastener upon the bunn, a magnetically active fastener assembly is typically disposed into at a certain place within the mold which is used to create the bunn (e.g., in most cases several such fastener assemblies are actually disposed within the mold and respectively operate in accordance with the following description of one such fastener assembly). The fastener member typically includes a magnetically attractive element or material on a first surface and a touch fastener portion on a second and opposed surface. An anchor portion is disposed upon the magnetically attractive element or material (e.g., the magnetically attractive element or material is “sandwiched” between the anchor portion and the touch fastener portion). The first magnetically attractive surface is made to be disposed upon or in close proximity to the magnetically active fastener assembly (e.g. the magnetic attraction facilitates the desired placement of the fastener member upon the fastener assembly or upon a certain location in a mold). Foam is then introduced into the mold and the bunn is moldably created (i.e., the fastener member is attached to the bunn with the opposed second touch fastener surface being exposed). The opposed second surface then cooperates with the fastener on the interior surface of the material to firmly secure the material over the formed bunn. Particularly, the fastener member is typically placed upon the bunn which resides under a formed seam of the material or fabric in order to strengthen the seam. Further, often the fastener member is placed within a formed trench within the tool in order to allow the formed material or fabric seams to be indented below the surface of the seat cushion in order to form a more overall pleasing aesthetic appearance and to accommodate the additional thickness of upholstery fabric that is created where the seam if stichably formed.

The magnetic fastener assembly therefore maintains the fastener member in a desired location within the mold and secures the fastener member to the molding surface in order to substantially prevent the ingress of the foam on the touch fastener portion (i.e., on the fastener elements) which would destroy or greatly and undesirably impair the overall utility of the touch fastener member and greatly increase the overall cost and waste of the object forming process (e.g., the formed cushion or bunn would be required to be “thrown out”). While current techniques do allow a seat assembly to make in the foregoing manner, such current techniques do have several drawbacks.

By way of example and without limitation, the magnetic fastener assemblies generate a widely dispersed magnetic field which does not readily aid (and in fact sometimes hinders) the placement of the fastener member at the desired location within the mold. Such a widely dispersed magnetic field also allows the fastener member to be easily dislodged from its desired mold location and the combination of such relatively easy dislodgement and the difficultly in accurately and easily placing the fastener member at the desired mold location, greatly and undesirably increases the likelihood that the fastener member will not be formed upon the bunn at a desired and utilitarian location and further greatly and undesirably increases the likelihood that foam incursion onto the fastening members will occur, thereby destroying the utility of the created bunn and undesirably increasing the overall cost and expense in the seat creation process.

There is therefore a need for a new and improved technique and strategy for overcoming these deficiencies and the present invention overcomes these deficiencies in a new and novel fashion.

### SUMMARY OF THE INVENTION

The present invention generally relates to a strategy and a technique which overcomes some or all of the above-referenced deficiencies associated with prior fastening strategies and techniques.

It is a first non-limiting object of the present invention to provide a fastening assembly and a fastening member which cooperatively and singularly overcome some or all of the above-referenced deficiencies associated with prior fastening strategies and techniques.

According to a first non-limiting aspect of the present invention, a touch fastener assembly is provided and includes a body having a longitudinal axis of symmetry and a magnetic attraction force which is only and substantially deployed along the longitudinal axis of symmetry; and a touch fastener having a first fastening surface and a second opposed surface having a certain magnetic attractable material which is adapted to be attracted to the magnetic attraction force which is only and substantially deployed along the longitudinal axis of symmetry, thereby securing the touch fastener to the body.

According to a second non-limiting aspect of the present invention, a touch fastener assembly is provided and includes a magnetic assembly having a first plurality of substantially identical poles which are operatively disposed along a first longitudinal axis and a second plurality of substantially identical poles which are operatively disposed along a second longitudinal axis; and a touch fastener having magnetically having a first surface including magnetically attractable material and a second and opposed fastening surface.

According to a third non-limiting embodiment of the present invention, a tool assembly is provided and includes a body portion which includes a molding cavity; and a touch fastener assembly which is secured to the body portion and which is operatively disposed within the cavity and wherein the touch fastener assembly includes a first linear deployment of substantially identical magnetic poles and a second linear deployment of substantially identical magnetic poles and wherein the second linear deployment of substantially identical magnetic poles is linearly coextensive to the first linear deployment of magnetic poles.

According to a fourth non-limiting aspect of the present invention, a method of creating an seat cushion assembly, the method comprising the steps of acquiring a mold having a cavity which includes a trench; placing a molding assembly within the trench, wherein the molding assembly includes a surface which is remote from the trench and which includes a longitudinal axis of symmetry upon which a magnetic field is constrained to only be operatively deployed; acquiring a fastening member, wherein the fastening member includes a first magnetically attractive surface which cooperates with the magnetic field emanating from the molding assembly to cause the fastening member to be substantially deployed along the longitudinal axis of symmetry of the fastening member and wherein the fastening member includes an opposed fastening surface which is remote from the molding assembly; placing foam within the mold; and moldably creating a cushion assembly from the foam and from the fastening member, wherein the fastening member is molded to the created cushion assembly, such that the opposed fastening surface exposably protrudes from the created cushion assembly; and acquiring outer material; placing a second fastening member upon an interior surface of the acquired outer material, wherein the second fastening member includes a second fastening surface which is complementary to the fastening surface of the first fastening member and wherein the second fastening surface exposably protrudes from the interior surface of the outer material; and substantially covering the created cushion assembly with the outer material while causing the second fastening surface to be coupled to the fastening surface of the first fastening member, thereby forming a seat cushion assembly.

These and other features, aspects, and advantages of the present invention will become apparent from a reading of the detailed description of the preferred embodiment of the invention, including the subjoined claims, and by reference to the following drawings.

### BRIEF DESCRIPTION OF THE DRAWINGS

FIG. 1 is a side schematic view of a mold or a tool which is made in accordance with the teachings of the preferred embodiment of the invention;

FIG. 2 is a top and partial phantom view of a fastening assembly which is made in accordance with the teachings of the preferred embodiment of the invention;

FIGS. 3(a-b) cooperatively form a flowchart which includes the various steps which cooperatively comprise the methodology of the preferred embodiment of the invention;

FIG. 4 is a side view of a cushion or bunn assembly which is made in accordance with the teachings of the preferred embodiment of the invention; and

FIG. 5 is a unassembled view of the bunn assembly which is shown in FIG. 4 in combination with outer fabric or material in accordance with the teachings of the preferred embodiment of the invention.

### DETAILED DESCRIPTION OF THE PREFERRED EMBODIMENTS OF THE INVENTION

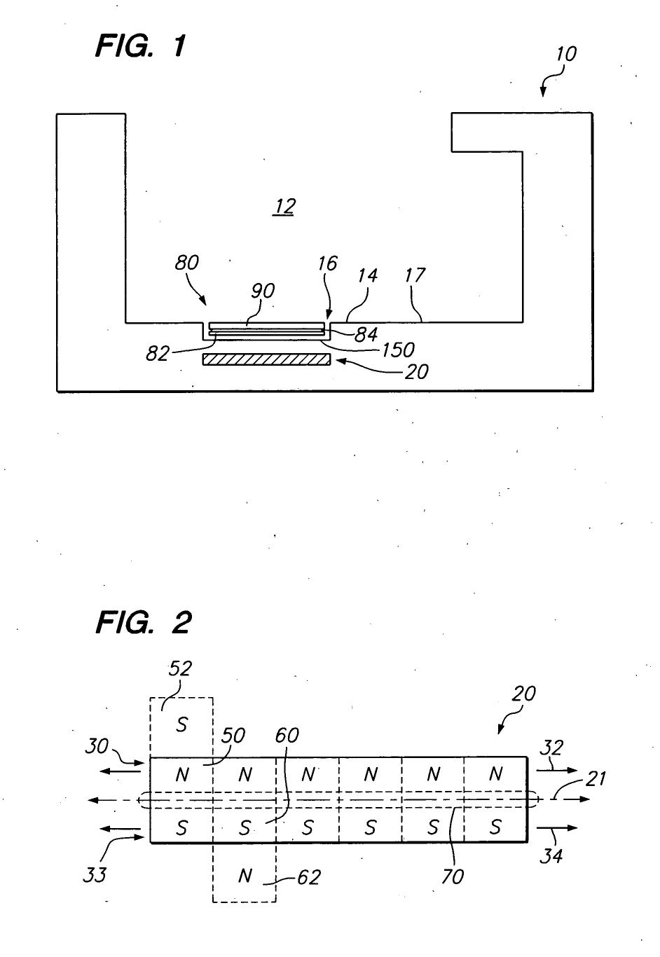

Referring now to FIG. 1, there is shown a tool or mold 10 which is made in accordance with the teachings of the preferred embodiment of the invention. It should be appreciated that in this description, the terms “mold” and tool” are interchangeably used and are meant to be generally construed to mean any object or assembly which is used to selectively create a desired object or assembly and that nothing in this description is meant to limit the various inventions to a particular type of mold/tool or to a particular type of created object, such as a seat cushion assembly.

Particularly, the mold/tool 10 includes an object forming cavity 12 having at least one surface 14 which includes a trench 16. Operatively deposited within the mold/tool 10, in closed proximity but remote from the trench 16, is a fastening assembly 20. It should be appreciated that the fastening assembly 20 may be integrally formed within the mold/tool 10 or fixedly or removably placed within the mold/tool 10 after the mold/tool 10 is formed and that the various inventions equally apply to mold/tools which operatively receive the fastening assembly 20 after they are formed and to mold/tools in which the fastening assembly 20 is integrally and/or removably formed or fixed.

As shown best in FIG. 2, the fastening assembly 20, in one non-limiting embodiment, has a generally rectangular shape and includes a longitudinal axis of symmetry 21. The fastening assembly 20 further includes a first linear array 30 of substantially identical magnetic poles (e.g., “north” type magnetic poles) which are operatively disposed along an axis 32 and a second linear array 33 of substantially identical magnetic poles (e.g., “south” type magnetic poles) which are operatively disposed along a second axis 34. The axis 32 is linearly co-extensive to the axis 34 and each of the axes 32, 34 are respectively and linearly coextensive to the axis 21. In one non-limiting embodiment, each of the arrays 30, 33 have substantially identical sizes and shapes and substantially identical numbers of oppositely magnetized poles.

In one non-limiting embodiment of the invention, each of the north poles, such as north pole 50, is formed within a respective structure or body which also includes a south pole, such as south pole 52. Similarly, each of the south poles, such as south pole 60, is formed within a respective structure or body which also includes a north pole, such as north pole 62. It should be appreciated that the arrays 30, 33 cooperate to form a magnetic field 70 which is substantially constrained to be generated upon and in the general vicinity of the longitudinal axis of symmetry 21, thereby being spatially fixed within a certain spatial area or volume and, due to the limited area and volume, being stronger than prior magnetic fields. In one non-limiting embodiment, the formed magnetic field 70 is constrained to be symmetrically or substantially entirely disposed along axis 21 and resides above the axis 21 at a distance of only about one inch long and further acts to automatically pull a magnetically attractive material upon the axis 21 in a “self-centered” manner (e.g., in a manner which substantially centers the pulled member along the axis 21 and upon the assembly 20). In one non-limiting embodiment, the width of the formed magnetic field 70 is only about one quarter to one half of an inch (e.g., the term “width” means the length that the field 70 lies upon the array 20 which is perpendicular to the axis 21). In one embodiment, an adhesive is applied along the periphery of the assembly 20 to hold the structure in place. Such an adhesive may include tape or glue.

As best shown in FIG. 1, a touch fastener member, such as touch fastener member 80, may be used by the tool 10 of the preferred embodiment of the invention. Particularly, in one non-limiting embodiment of the invention, the touch fastener member 80 includes a hook or adhering portion 82 which is coupled to magnetically attractive material, such as material 84 (e.g., metal type material). The touch fastener member 80 may also, but not necessarily, include an anchor portion 90 which is also coupled to the magnetically attractive material 84. In an alternate embodiment, the surface of the material 84 which is shown as being coupled to portion 90 is exposed. Thus, the touch fastener member 82, in this non-limiting embodiment, includes a first adhering or fastening surface 82 and a second opposed surface 90 which cooperatively “sandwiches” or contains the magnetically attractive material 84. It should be appreciated that the various inventions are not limited to a particular type of fastening member, but that substantially any type of fastening member may be used by the invention. In one non-limiting embodiment of the invention, the hook or adhering portion 82 may comprise Velcro® and that portion 90 includes hooks or anchors which help secure the touch fastener member 80 into a bunn or formed cushion in a manner which is fully shown below. Examples of such a fastener member 80 are described within United States Patent Application Numbers US 2002/0058123 A1 and US 2004/0195877 A1 which are each fully and completely incorporated herein by reference, word for word and paragraph for paragraph.

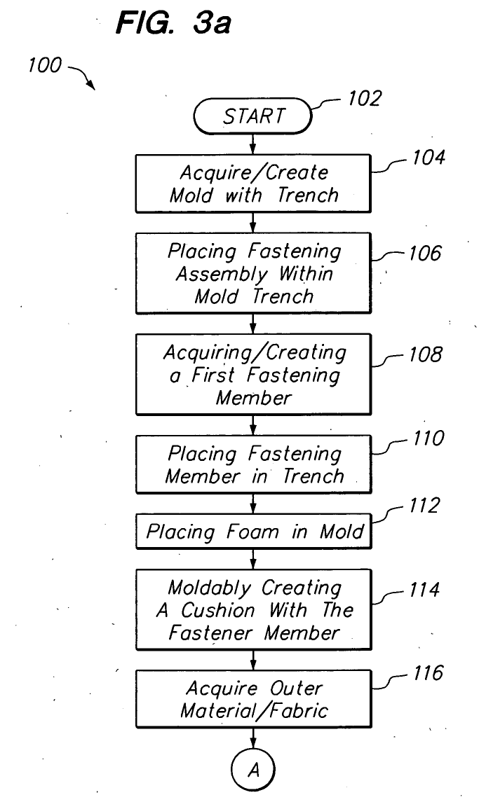

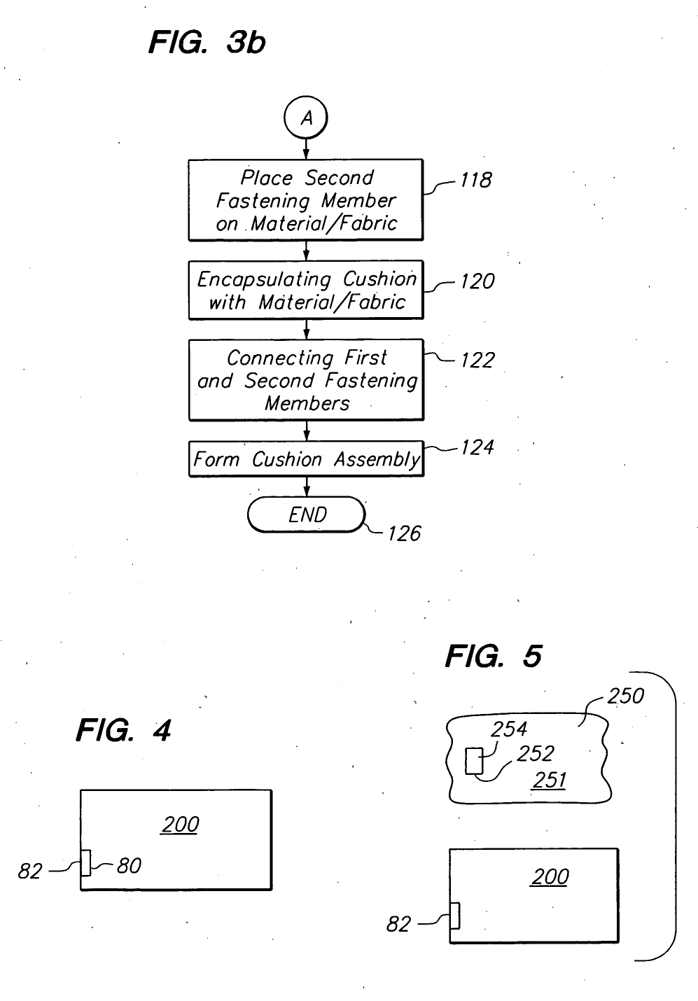

Referring now to FIGS. 3(a-b), there is shown a flowchart 100 which comprises the steps associated with the methodology of the preferred embodiment of the invention.

Particularly, the flowchart or methodology 100 includes a first step 102 which denotes the start or desire to begin creating an object (e.g., a seat cushion) according to the various inventions. Step 102 is followed by step 104 in which a mold/tool, such as mold/tool 10, is created or acquired. Step 104 is followed by step 106 in which in which the fastening assembly, such as fastening assembly 20, is placed in close proximity to the trench 16. In one non-limiting embodiment of the invention, the fastening assembly 20 is integrally formed with the tool/mold 10 and in another non-limiting embodiment of the invention the fastening assembly 20 is formed within the tool/mold 10 after the tool/mold 10 is formed. In one non-limiting embodiment, the center point of the fastener assembly lies about one to about three inches below the lowest point of the trench 16 (e.g., the term “lowest point” means the lowest point below the molding surface 17).

Step 106 is followed by step 108 in which a fastening member, such as fastening member 80, is formed or acquired. Step 110 follows step 108 and, in this step 110, the fastening member, such as fastening member 80, is placed within the trench, such as trench 16. It should be appreciated that the self-centered nature of the formed magnetic field 70 (which permeates through the mold/tool 10, such as the bottom wall 150 of the trench 16), allows the fastener to be quickly and easily placed within the trench 16 (i.e., the magnetically attractive material 84 is automatically drawn upon the axis 21), and dramatically increases the likelihood that the fastener assembly 80 will remain seated within the trench 16 and against the bottom wall 150 of the trench, thereby substantially reducing the likelihood that molding material will be deposited upon the fastener portion 82.

Step 112 follows step 110 and, in this step 112, foam is placed within the mold and in step 114, which follows step 112, the mold/tool 10 uses the foam to create a cushion or bunn 200 which is shown in FIG. 4. Particularly, the formed bunn assembly 200 is removed from the mold/tool 10 in step 114 and, as shown best in FIG. 4, includes the fastener assembly 80 having the adhering portion 82 being protrudingly exposed. As should now be appreciated, in one non-limiting embodiment, the foam is “molded around” the anchor portion 90 which acts to secure the fastener assembly within the formed bunn 200.

Step 116 follows step 114 and, in this step 116, material or fabric 250 (see FIG. 5) is obtained and the interior surface 251 (the surface of the material or fabric 250 which comes into actual contact with the bunn or cushion 200) includes a touch type fastener 252 having an exposed and protruding surface 254 which is complementary to the exposed touch fastener surface 82 (e.g., the term “complementary” means that surface 82 will touchably adhere to the surface 82 and each surface 82, 254 may respectively comprise a complementary Velcro® surface). Particularly, the fastener 252 is securely placed upon (e.g., “sewn into”) the surface 251 in step 118 which follows step 116. Further, step 120 follows step 118 and, in this step 120, the material or fabric 250 is made to substantially encapsulate the bunn or cushion 200. Step 122 follows step 120 (or is concurrently achieved or performed) and, in this step 122, the fastener surfaces 82 and 254 are touchably coupled, thereby securing the fabric or material 250 over the bunn 200. Such a touch fastener connection is made in step 122 which follows step 120. Step 124 follows step 122 and, in this step 124, the material or fabric completely encapsulates the bunn or cushion assembly 200, thereby forming the cushion assembly. Step 126 follows step 124 and, in this step 126, the methodology 100 is ended. It should be appreciated that in the foregoing methodology 100 the fastening assembly 20 may be placed substantially anywhere within and/or upon the mold/tool 10 and that the fastener assembly 20 may also be placed anywhere within the tool 10. Further, it should be appreciated that several fastener assemblies may be placed at various locations within/upon the mold/tool 10 in order to allow several touch type fasteners, such as fastener 80, to be selectively deployed at several locations upon the formed bunn or cushion 200.

It is to be understood that the various inventions are not limited to the exact construction and methodology which has been described above, but that various changes and modifications may be made without departing from the spirit and the scope of the inventions as are more fully delineated in the following claims.

1) A touch fastener assembly comprising a body having a longitudinal axis of symmetry and a magnetic attraction force which is only and substantially deployed along said longitudinal axis of symmetry; and a touch fastener having a first fastening surface and a second opposed surface having a certain magnetic attractable material which is adapted to be attracted to said magnetic attraction force which is only and substantially deployed along said longitudinal axis of symmetry, thereby securing said touch fastener to said body.

2) The touch fastener assembly of claim 1 wherein said body has a substantially rectangular shape.

3) The touch fastener assembly of claim 1 wherein said first fastening surface comprises Velcro.

4) A touch fastener assembly comprising a magnetic assembly having a first plurality of substantially identical poles which are operatively disposed along a first longitudinal axis and a second plurality of substantially identical poles which are operatively disposed along a second longitudinal axis; and a touch fastener having magnetically having a first surface including magnetically attractable material and a second and opposed fastening surface.

5) The touch fastener assembly of claim 4 wherein said first plurality of substantially identical poles each comprise north poles.

6) The touch fastener assembly of claim 5 wherein said second plurality of substantially identical poles each comprise south poles.

7) The touch fastener assembly of claim 6 wherein said opposed fastening surface comprises Velcro.

8) The touch fastener assembly of claim 6 wherein said magnetic assembly is substantially rectangular in shape.

9) The touch fastener assembly of claim 8 wherein said touch fastener assembly is constructed from metal.

10) The touch fastener assembly of claim 8 wherein said magnetic assembly has a longitudinal axis of symmetry and wherein said first plurality of substantially identical poles abut said second plurality of substantially identical poles along said longitudinal axis of symmetry.

11) A tool assembly comprising a body portion which includes a molding cavity; and a touch fastener assembly which is secured to said body portion and which is operatively disposed within said cavity and wherein said touch fastener assembly includes a first linear deployment of substantially identical magnetic poles and a second linear deployment of substantially identical magnetic poles and wherein said second linear deployment of substantially identical magnetic poles is linearly coextensive to said first linear deployment of magnetic poles.

12) The tool assembly of claim 11 wherein said touch fastener assembly includes a longitudinal axis of symmetry and wherein said first and second linear deployments substantially abut along said longitudinal axis of symmetry.

13) The tool assembly of claim 12 wherein said touch fastener assembly further includes a fastener member having a first surface which is magnetically attracted to said first and second deployments and a second opposed surface which includes a fastening portion.

14) The tool assembly of claim 13 wherein said fastening portion comprises Velcro.

15) The tool assembly of claim 14 wherein said second surface includes a magnetically attractable material.

16) The tool assembly lf claim 15 wherein said first and second deployments cooperatively provide a magnetically attractive force which is only and substantially aligned along said longitudinal axis of symmetry.

17) A method of creating an seat cushion assembly, said method comprising the steps of acquiring a mold having a cavity, which includes a trench; placing a molding assembly within said trench, wherein said molding assembly includes a surface which is remote from said trench and which includes a longitudinal axis of symmetry upon which a magnetic field is constrained to only be operatively deployed; acquiring a fastening member, wherein said fastening member includes a first magnetically attractive surface which cooperates with said magnetic field emanating from said molding assembly to cause said fastening member to be substantially deployed along the longitudinal axis of symmetry of said fastening member and wherein said fastening member includes an opposed fastening surface which is remote from said molding assembly; placing foam within said mold; and moldably creating a cushion assembly from said foam and from said fastening member, wherein said fastening member is molded to said created cushion assembly, such that said opposed fastening surface exposably protrudes from said created cushion assembly; and acquiring outer material; placing a second fastening member upon an interior surface of said acquired outer material, wherein said second fastening member includes a second fastening surface which is complementary to said fastening surface of said first fastening member and wherein said second fastening surface exposably protrudes from said interior surface of said outer material; and substantially covering said created cushion assembly with said outer material while causing said second fastening surface to be coupled to said fastening surface of said first fastening member, thereby forming a seat cushion assembly.

18) The method of claim 17 wherein said fastening surface of said first fastening member comprises Velcro.

19) The method of claim 18 wherein said first fastening member is constructed from metal.

20) The method of claim 19 wherein said first fastening member is substantially rectangular in shape.
